(19) United States
(12) Patent Application Publication
(10) Pub. No.: US 2012/0003894 A1
(43) Pub. Date: Jan. 5, 2012

(54) ELECTRET FILTER FOR VEHICULAR COMPARTMENT INTERIOR AND PRODUCTION METHOD THEREOF

(75) Inventors: Nobuhiro SUMIYA, Hekinan-shi (JP); Toshiyuki ARIO, Ogaki-shi (JP)

(73) Assignee: TOYOTA BOSHOKU KABUSHIKI KAISHA, Aichi-ken (JP)

(21) Appl. No.: 13/169,298

(22) Filed: Jun. 27, 2011

(30) Foreign Application Priority Data
Jul. 2, 2010 (JP) 2010-152449

(51) Int. Cl. D04H 5/00; H05H 1/42; D04H 13/00

(52) U.S. Cl. 442/334; 442/327; 264/483

(57) ABSTRACT

The electret filter for vehicular compartment interior of the present invention has a nonwoven fabric which contains a polyolefin resin having a melt flow rate of 1,000 to 3,000 g per 10 minutes, and a heat generation amount of 2.0 to 10.0 J/g in a temperature range from 80° C. to 120° C. when the temperature of the polyolefin resin is elevated at a rate of 10° C. per minute in a differential scanning calorimetric analysis. The electret filter for vehicular compartment interior is manufactured by a method including a process for producing the nonwoven fabric by melt-blowing method, and a process for electrostatic charging the nonwoven fabric by means of corona discharge.

### INCORPORATION BY REFERENCE

The present application claims priority under 35 U.S.C. §119 of Japanese Patent Application No. 2010-152449, filed on Jul. 2, 2010, the disclosure of which is expressly incorporated by reference herein in its entirety.

### BACKGROUND OF THE INVENTION

1. Field of the Invention

The present invention related to an electret filter for a vehicular compartment interior and a production method thereof. More specifically the present invention relates to an electret filter for a vehicular compartment interior which has a dust collecting function in addition to a filtering function as a typical function of an air filter, and cleans the air in the vehicular compartment when the electret filter is provided in a flow passage or the like for an air to be supplied from an air conditioner into a vehicular compartment, thereby bringing the vehicular compartment interior into a comfortable atmosphere, and improving an occupant comfort; and a production method thereof.

2. Related Art

Air conditioners are installed in substantially all the vehicles such as an automobile and bus, and a temperature and a humidity in a compartment of each vehicle are controlled irrespectively of the environments such as a hot season, a cold season, and a rainfall time. For the purpose of bringing the vehicular compartment interior into a more comfortable atmosphere to thereby improve an occupant comfort, it is required that fine particles contained in an air to be introduced from the exterior of the vehicular compartment into the interior thereof, are removed from the air. A filter is provided in a flow passage from an air conditioner for supplying the air therethrough such as a warm air and a cool air. However, a simple filtering function of the filter occasionally fails to sufficiently remove fine particles. An electret filter has been developed in which the filter is electretized to additionally possess a dust collecting function for adsorbing fine particles by electrostaticity, and installation of such an electret filter has been attempted, for example, in Japanese Unexamined Patent Application Publication No. H09-225229.

### SUMMARY OF THE INVENTION

Japanese Unexamined Patent Application Publication No. H09-225229. discloses an air filter material in which a supporting layer consisting of a colored polyolefin-based nonwoven fabric and a filtering layer consisting of an electretized polyolefin-based nonwoven fabric are laminated to integrate with each other. It is further described therein that the air filter material is to be utilized in those applications where importance is particularly given to external appearances, such as an air cleaner for a vehicular compartment interior. Although it is described therein that examples of the polyolefin to be used for the electretized nonwoven fabric include polypropylene, no descriptions are found concerning the details of the resin such as a melt flow rate.

It is therefore an object of the present invention to provide: an electret filter for a vehicular compartment interior (hereinafter simply referred to as “electret filter”, as the case may be), which has a dust collecting function in addition to a filtering function as a typical function of an air filter, and cleans the air in the vehicular compartment when the electret filter is provided in a flow passage or the like for an air to be supplied from an air conditioner into a vehicular compartment, thereby bringing the vehicular compartment interior into a comfortable atmosphere, and improving an occupant comfort; and a production method thereof.

Since vehicles are used in various places ranging from a cold area to a tropical area, the temperature of the vehicular compartment interior is sometimes a low temperature at about −30° C., or a high temperature at about 80° C., for example. It is therefore necessary for the electret filter to keep its sufficient dust removing and dust collecting performances over such a wide temperature range. However, no materials have been disclosed up to now, which are to be provided to prevent deterioration of the performances due to a thermal load upon usage over a long time at a high temperature, particularly as high as 80° C. The thermal property of a polyolefin resin as a main material for an electret filter is investigated, and it is resultingly found out that a generation of an intermediate phase (smectic structure) between a crystal and an amorphous is effective for restricting deterioration of the performances due to a thermal load under high temperature. In other words, it is found out that deterioration of the performances is sufficiently restricted, when a heat generation amount (intermediate phase-transiting heat generation amount) of an applicable resin upon transition from an intermediate phase to an α phase, is large.

The present invention is completed on the basis of the discoveries.

The present invention is as follows.

1. An electret filter for vehicular compartment interior, comprising a nonwoven fabric which comprises a polyolefin resin having a melt flow rate (hereinafter, abbreviated to “MFR”) of 1,000 to 3,000 g per 10 minutes, and a heat generation amount (intermediate phase-transiting heat generation amount) of 2.0 to 10.0 J/g in a temperature range from 80° C. to 120° C. when the temperature of the polyolefin resin is elevated at a rate of 10° C. per minute in a differential scanning calorimetric analysis.
2. The electret filter for vehicular compartment interior according to 1 above, wherein a diameter of a fiber in the nonwoven fabric is in the range from 0.3 to 150 μm.
3. A manufacturing method of an electret filter for vehicular compartment interior, comprising:

a process for producing by melt-blowing method, a nonwoven fabric which comprises a polyolefin resin having a MFR of 1,000 to 3,000 g per 10 minutes, and a heat generation amount (intermediate phase-transiting heat generation amount) of 2.0 to 10.0 J/g in a temperature range from 80° C. to 120° C. when the temperature of the polyolefin resin is elevated at a rate of 10° C. per minute in a differential scanning calorimetric analysis, and

a process for electrostatic charging the nonwoven fabric by means of corona discharge.

The electret filter for a vehicular compartment interior of the present invention has a nonwoven fabric containing a polyolefin resin which has a large amount of intermediate phase, and has a larger intermediate phase-transiting heat generation amount in a temperature range from 80° C. to 120° C. in measurement adopting a differential scanning calorimeter. Thus, it is enabled to restrict deterioration of dust removing and dust collecting performances of the electret filter even when the same is used in a vehicular compartment in which the temperature is occasionally elevated to as high as 80° C., or is used in a vehicular compartment for a long time. It is also enabled to clean the air in the vehicular compartment and to keep the vehicular compartment interior in a comfortable atmosphere.

In the case where the diameter of a fiber in the nonwoven fabric is in the range from 0.3 to 150 μm, the intermediate phase is formed more easily and more sufficiently, thereby enabling to clean the air in the vehicular compartment and to bring the vehicular compartment interior into a particularly comfortable atmosphere.

According to the manufacturing method of the electret filter for a vehicular compartment interior of the present invention, a nonwoven fabric having a required intermediate phase-transiting heat generation amount can be obtained by a melt-blowing method since the MFR of the polyolefin resin used for producing the nonwoven fabric. After that, when the nonwoven fabric is subjected to electrostatic charging, an electret filter can be easily manufactured which is sufficiently electretized. Further, since the MFR of the resin is high, it is easy to spin the resin upon melt-blowing, thereby improving a productivity of the nonwoven fabric as well.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view of an example of a cross-sectional structure of an electret filter according to the present invention;

FIG. 2 is a schematic view of another example of a cross-sectional structure of the electret filter according to the present invention;

FIG. 3 is a schematic perspective view of an example of the electret filter according to the present invention;

FIG. 4 is a cross-sectional view of the electret filter shown in FIG. 3 taken along a line E-E; and

FIG. 5 is an explanatory schematic view of a dust collection efficiency measuring apparatus.

### DETAILED DESCRIPTION OF THE INVENTION

Hereinafter, the present invention is described in detail using FIGS. 1 to 5. The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### [1] Electret Filter for Vehicular Compartment Interior

The electret filter for a vehicular compartment interior of the present invention has a nonwoven fabric which contains a polyolefin resin having an MFR of 1,000 to 3,000 g per 10 minutes, and a heat generation amount (intermediate phase-transiting heat generation amount) of 2.0 to 10.0 J/g in a temperature range from 80° C. to 120° C. when the temperature of the polyolefin resin is elevated at a rate of 10° C. per minute in a differential scanning calorimetric analysis. A fiber constituting the nonwoven fabric may be of only the above-mentioned specified polyolefin resin, or of a thermoplastic resin composition including the above-mentioned specified polyolefin resin and other thermoplastic resin such as other polyolefin resin, or of a thermoplastic resin composition including the above-mentioned specified polyolefin resin and an additive described later.

The “nonwoven fabric” functions as a dust removing layer and/or a dust collecting layer (hereinafter, these layers are collectively called a “dust collecting layer”) in the electret filter. Further, this nonwoven fabric is preferably electrostatic charged to have a surface electric charge density described later.

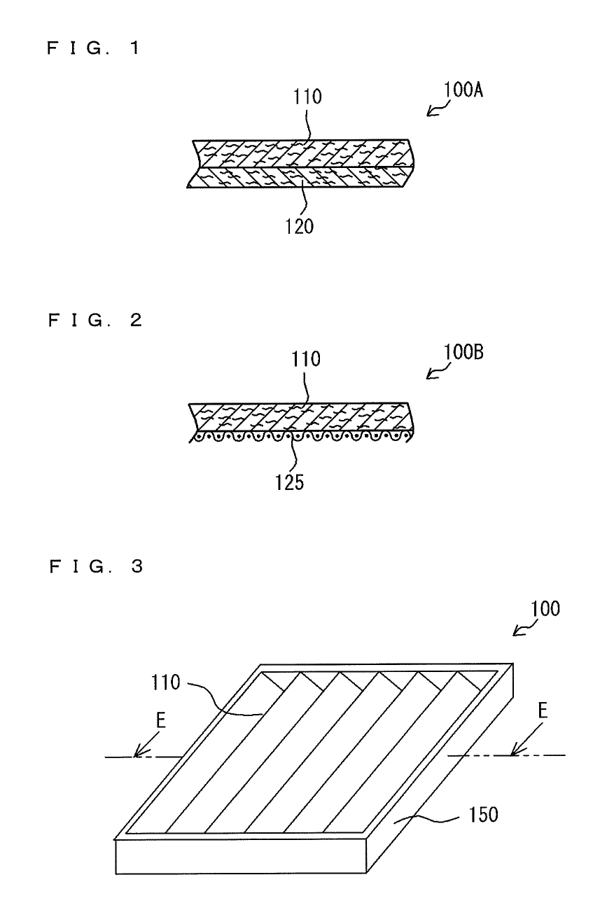

The electret filter of the present invention has, as described above, a dust collecting layer consisting of a specific nonwoven fabric and is allowed to have a cross-sectional structure shown, for example in FIG. 1 or FIG. 2. The electret filter 100A shown in FIG. 1 has a dust collecting layer 110 and a supporting layer 120 which is consisting of a fiber aggregate, is arranged at one surface side of the dust collecting layer 110, and keeps the shape of the dust collecting layer 110. In turn, the electret filter 100B shown in FIG. 2 has a dust collecting layer 110 and a reinforcing member 125 which is consisting of a net-shaped article, and is arranged at one surface side of the dust collecting layer 110. Examples of other configurations of the electret filter include an electret filter, which does not include a supporting layer 120 in FIG. 1, i.e., which is consisting of only a dust collecting layer 110, an electret filter including a reinforcing member 125 shown in FIG. 2 which is arranged inside the supporting layer 120 of FIG. 1, and the like.

The above-mentioned “polyolefin resin” contained in the nonwoven fabric has an MFR of 1,000 to 3,000 g per 10 minutes. The MFR is preferably in the range from 1,000 to 2,000 g per 10 minutes, more preferably from 1,000 to 1,800 g per 10 minutes, and particularly from 1,200 to 1,500 g per 10 minutes. When the MFR of the polyolefin resin is large, the intermediate phase-transiting heat generation amount thereof is large, and deterioration of dust removing and dust collecting performances of the electret filter are sufficiently restricted even when the nonwoven fabric containing the polyolefin resin is used in a vehicular compartment in which the temperature is occasionally elevated to as high as 80° C., or is used in a vehicular compartment for a long time.

The MFR is a value measured according to JIS K 7210. Concerning the temperature and load upon measurement, the measurement is conducted at a temperature of 190° C. and a load of 21.18 N when the polyolefin resin is a polyethylene resin, and at a temperature of 230° C. and a load of 21.18 N when the polyolefin resin is a polypropylene resin.

The heat generation amount (intermediate phase-transiting heat generation amount) of the polyolefin resin in a temperature range from 80° C. to 120° C. when the polyolefin resin is analyzed with a differential scanning calorimeter at a temperature elevating rate of 10° C. per minute is in the range from 2.0 to 10.0 J/g. The intermediate phase-transiting heat generation amount is preferably from 2.5 to 10.0 J/g, more preferably from 3.0 to 10.0 J/g, furthermore preferably from 3.5 to 10.0 J/g, and particularly from 4.0 to 10.0 J/g. This heat generation accompanies to conversion of an intermediate phase to an α phase. When the intermediate phase-transiting heat generation amount is large, and deterioration of dust removing and dust collecting performances of the electret filter are sufficiently restricted even when the nonwoven fabric containing the polyolefin resin is used in a vehicular compartment in which the temperature is occasionally elevated to as high as 80° C., or is used in a vehicular compartment for a long time.

The differential scanning calorimetric analysis can be conducted using a differential scanning calorimeter. For example, a commercially product “DSC-60” manufactured by Shimadzu Corp. can be used. The intermediate phase-transiting heat generation amount is a value which is measured using the differential scanning calorimeter under conditions of a sample weight of 5 mg, a temperature range of 40° C. (heat starting temperature) to 200° C., and a temperature elevating rate of 10° C. per minute. Further, the intermediate phase-transiting heat generation amount under the above conditions is automatically calculated by a data analyzing device appended to the differential scanning calorimeter.

The polyolefin resin is not particularly limited, and example thereof includes a polypropylene-based resin such as propylene homopolymer, ethylene propylene random copolymer, and ethylene propylene block copolymer; a polyethylene-based resin such as high pressure processed low-density polyethylene, medium/low pressure processed low-density polyethylene, and high-density polyethylene; and the like. The polyolefin resin is preferably a polypropylene-based resin and a high-density polyethylene, which are light-weighted and are high in strength and rigidity. Among these, a polypropylene-based resin is particularly preferred.

The polypropylene-based resin may be, as mentioned above, a propylene homopolymer or a copolymer of propylene and other α-olefin other than propylene. In the invention, a propylene homopolymer, and particularly isotactic propylene homopolymer is preferable. When the polypropylene-based resin is a copolymer, examples of the α-olefin include ethylene, l-butene, and the like. Among these, ethylene is often used. Additionally, in the case of a copolymer, propylene content is preferably 80% or more by mol, and particularly 90% or more by mol based on 100% by mol of the total of monomers to be used. Physical properties of the applicable polypropylene-based resin other than MFR and intermediate phase-transiting heat generation amount are not particularly limited.

In the case of a polyolefin resin having a higher MFR, larger amount of the intermediate phase can be generated, while electrostatic charging efficiency tends to be deteriorated. Nonetheless, to restrict such a deterioration of the electrostatic charging efficiency, i.e., to restrict deterioration of efficiencies of dust removal and dust collection at the initial stage, a nonwoven fabric consisting of a composition containing the polyolefin resin and an additive. Examples of the additive include an antioxidant, a light resistance improving agent, and the like.

The antioxidant is not particularly limited. Examples of the antioxidant include N-phenyl-1,1,3,3-tetramethylbutylnaphthalene-1-amine; a diphenylamine derivative (reaction product of diphenylamine and 2,4,4-trimethylpentene); pentaerythritol tetrakis(3-(3,5-di-tert-butyl-4-hydroxyphenyl)propionate); octadecyl 3-(3,5-di-tert-butyl-4-hydroxyphenyl)propionate; hexamethylene bis[3-(3,5-di-tert-butyl-4-hydroxyphenyl)propionate]; thio-diethylene bis[3-(3,5-di-tert-butyl-4-hydroxyphenyl)propionate]; 3,5-bis(1,1-dimethyl-ethyl)-4-hydroxy-C₇ to C₉ side-chain alkyl benzenepropanoate; and the like. Among these compounds, pentaerythritol tetrakis(3-(3,5-di-tert-butyl-4-hydroxyphenyl)propionate) is preferable. The antioxidant may be used singly or in combination of two or more types thereof.

The light resistance improving agent is not particularly limited. Examples of the light resistance improving agent include an ultraviolet absorber such as a benzotriazole-based compound and a hydroxyphenyltriazine-based compound, and a light stabilizer such as a hindered amine-based compound.

Examples of the benzotriazole-based ultraviolet absorber include 2-(2-hydroxy-5-tert-butylphenyl)-2H-benzotriazole; a mixture of 5% of 2-methoxy-1-methylethyl acetate and 95% of 3-(2H-benzotriazole-2-yl)-5-(1,1-dimethylethyl)-4-hydroxy-C₇ to C₉ side-chain or straight-chain alkyl benzenepropanoate; a mixture of octyl-3-[3-tert-butyl-4-hydroxy-5-(5-chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate; a mixture of 5% of 2-methoxy-1-methylethyl acetate and 95% of 3-(2H-benzotriazole-2-yl)-5-(1,1-dimethylethyl)-4-hydroxy-C₇ to C₉ side-chain or straight-chain alkyl benzenepropanoate; 2-(2H-benzotriazole-2-yl)-4,6-bis(1-methyl-1-phenylethyl)phenol; a reaction product of methyl 3-(3-(2H-benzotriazole-2-yl)-5-tert-butyl-4-hydroxyphenyl)propionate and polyethylene glycol 300; and the like. The benzotriazole-based ultraviolet absorber may be used singly or in combination of two or more types thereof.

Examples of the hydroxyphenyltriazine-based ultraviolet absorber include a mixture of, 85% of a reaction product of 85% of 2-(4,6-bis(2,4-dimethylphenyl)-1,3,5-triazine-2-yl)-5-hydroxyphenyl and 15% of oxirane (which is preferably a [(C₁₀ to C₁₆ alkyloxy)methyl]oxirane, and more preferably a [(C₁₂ to C₁₃ alkyloxy)methyl]oxirane), and 15% of 1-methoxy-2-propanol; a reaction product of 2-(2,4-dihydroxyphenyl)-4,6-bis(2,4-dimethylphenyl)-1,3,5-triazine and (2-ethylhexyl)glycidic acid ester; 2,4-bis[2-hydroxy-4-butoxyphenyl]-6-(2,4-dibutoxyphenyl)-1,3,5-triazine; and the like. The hydroxyphenyltriazine-based ultraviolet absorber may be used singly or in combination of two or more types thereof.

Examples of the light stabilizer containing the hindered amine-based compound include a polymerization product of 50% dimethyl succinate and 50% of 4-hydroxy-2,2,6,6-tetramethyl-1-piperidineethanol; N,N′,N″,N″′-tetrakis-(4,6-bis(butyl-(N-methyl-2,2,6,6-tetramethylpiperidine-4-yl)amino)-triazine-2-yl)-4,7-diazadecane-1,10-diamine, decanoic diacid bis(2,2,6,6-tetramethyl-1-(octyloxy)-4-piperidinyl)ester; a reaction product of 1,1-dimethylethylhydroperoxide and octane, bis(1,2,2,6,6-pentamethyl-4-piperidyl)[[3,5-bis(1,1-dimethylethyl)-4-hydroxyphenyl]methyl]butylmalonate; a reaction product of (i) a reaction product of cyclohexane and peroxidized N-butyl 2,2,6,6-tetramethyl-4-piperidineamine-2,4,6-trichloro-1,3,5-triazine, and (ii) 2-amino-ethanol; a mixture of 70% to 80% of bis(1,2,2,6,6-pentamethyl-4-piperidyl)sebacate and 30% to 20% of methyl 1,2,2,6,6-pentamethyl-4-piperidyl sebacate; and the like. The light stabilizer may be used singly or in combination of two or more types thereof.

The content ratio of the total amount of the additive(s) in the polyolefin resin composition is not particularly limited. It is preferably in the range from 0.1% to 5% by weight and particularly from 0.2% to 5% by weight based on 100% by weight of the total amount of the polyolefin resin and the additive(s). When the content ration of the additive(s) is in the range from 0.1% to 5% by weight, efficiencies of dust removal and dust collection can be improved and a flow-through resistance can be lowered.

The fiber diameter obtained from the polyolefin resin or the polyolefin resin composition constituting the nonwoven fabric is not particularly limited. It is preferably in the range from 0.3 to 150 μm, more preferably from 1 to 100 μm, further preferably from 1 to 50 μm, and particularly from 2 and 20 μm. When the nonwoven fabric is formed by melt-blowing method, the fiber diameter can be further decreased, down to 0.3 to 3 μm, for example. The fiber diameter can be decreased, down to 0.5 to 3 and also down to 1 to 3 μm. Since a fiber having a smaller diameter is cooled more rapidly upon spinning, an intermediate phase is apt to be generated such that an intermediate phase-transiting heat generation amount is more increased. Thus, deterioration of dust removing and dust collecting performances of the electret filter are sufficiently restricted even when the nonwoven fabric containing the polyolefin resin is used in a vehicular compartment in which the temperature is occasionally elevated to as high as 80° C., or is used in a vehicular compartment for a long time.

The weight per unit area of the dust collecting layer is preferably in the range from 10 to 50 g/m².

As described above, the electret filter of the present invention is allowed to include the dust collecting layer 110 and the supporting layer 120 as shown in FIG. 1. The constituent material of the supporting layer 120 is preferably a woven fabric or nonwoven fabric obtained using a composition containing a thermoplastic resin including a polyolefin resin such as a polypropylene-based resin. In this case, the weight per unit area of the supporting layer 120 is preferably in the range from 60 to 120 g/m². The supporting layer 120 may have a dust removing or dust collecting function. Further, the supporting layer 120 may be electrostatic charged.

In the embodiment shown in FIG. 1, the dust collecting layer 110 and supporting layer 120 may be integrated with each other in a manner to be independent of each other, or may be integrated with each other in a manner that fibers constituting the dust collecting layer 110 and fibers constituting the supporting layer 120 are entangled with each other at an interface therebetween.

In turn, the net-shaped article constituting the reinforcing member 125 in the electret filter shown in FIG. 2 may be made from a composition containing a thermoplastic resin including a polyolefin resin.

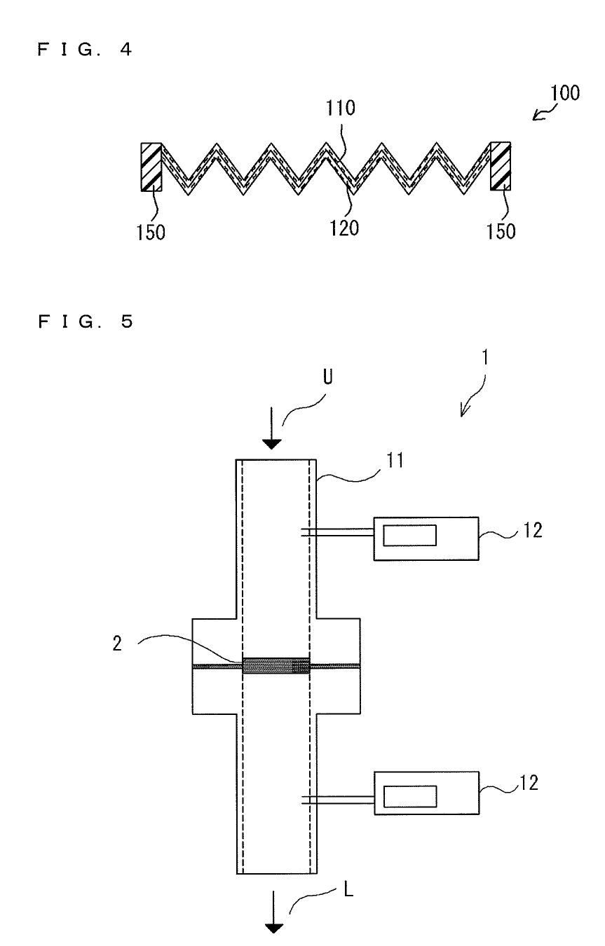

External appearances of the electret filter of the present invention are exemplified in FIGS. 3 and 4. The electret filter 100 shown in FIGS. 3 and 4 is an embodiment wherein a laminated body is pleated consisting of a dust collecting layer 110 containing a nonwoven fabric according to the present invention, and a supporting layer 120, and wherein a holding frame 150 is provided to hold the periphery of the laminated body. When a nonwoven fabric exemplarily in a band shape is folded in its lengthwise direction to have pleat parts, fine particles and foreign matters to be removed or collected can be filtered and adsorbed by a wider area of the nonwoven fabric for the dust collecting layer 110. In the present invention, the electret filter is not limited to the configuration shown in FIGS. 3 and 4, and the electret filter may have a flat nonwoven fabric for dust collecting layer without a supporting layer.

The temperature in the vehicular compartment interior is not particularly limited in which the electret filter is usable. The electret filter may be used at a temperature range from an extremely low temperature (−30° C., for example) to a high temperature (100° C., for example). The electret filter of the present invention is usable even at such a high temperature of 80° C.

### [2] Manufacturing Method of Electret Filter for Vehicular Compartment Interior

The manufacturing method of an electret filter for a vehicular compartment interior of the present invention is provided with a nonwoven fabric producing process in which a nonwoven fabric containing a polyolefin resin having a MFR of 1,000 to 3,000 g per 10 minutes, and a heat generation amount (intermediate phase-transiting heat generation amount) of 2.0 to 10.0 J/g in a temperature range from 80° C. to 120° C. when the temperature of the polyolefin resin is elevated at a rate of 10° C. per minute in a differential scanning calorimetric analysis is produced by melt-blowing method, and an electrostatic charging process in which the nonwoven fabric is subjected to corona discharge.

In the present invention, the respective descriptions in the item [1] are directly applicable, concerning the types of the polyolefin resin, the preferable polyolefin resin, and the MFR and intermediate phase-transiting heat generation amount of the polyolefin resin.

In the nonwoven fabric producing process, a polyolefin resin or a polyolefin resin composition containing a polyolefin resin and an additive is subjected to melt-blowing method to form a nonwoven fabric for the dust collecting layer. Concerning the MFR of the polyolefin resin to be contained in the nonwoven fabric, this value of the resin before production of a nonwoven fabric is substantially the same as that of the resin after the production. When a polyolefin resin having the above-mentioned specified MFR is used as a starting resin, an intermediate phase can be readily formed to thereby increase an intermediate phase-transiting heat generation amount.

The above-mentioned “melt-blowing method” is a method for forming a nonwoven fabric by blowing an airflow to a molten resin discharged from an extruder, cumulating an extruded fiber having a small diameter onto a conveyor or the like, and entangling and fusion bonding them with one another. The method is desirable for production of a nonwoven fabric consisting of a fiber having a small diameter.

Forming conditions in the melt-blowing method are not particularly limited, such as a nozzle orifice diameter, a nozzle temperature, a discharging amount of a molten resin, a drawing air temperature, and a drawing air pressure. The drawing air temperature is preferably made to be low. It is the reason that when the extruded fibers are rapidly cooled, an intermediate phase is apt to be generated in the polyolefin resin to thereby increase an intermediate phase-transiting heat generation amount. The drawing air temperature is preferably in the range from 20° C. to 250° C., and particularly from 100° C. to 200° C. In turn, lower drawing air temperatures lead to difficulty in fusion bonding among the fibers, thereby occasionally requiring a condition that a distance between the nozzle and the conveyor is shortened, for example.

In the case of forming a nonwoven fabric by the melt-blowing method, when the diameter of the extruded fiber is made to be decreased, a larger amount of intermediate phase can be generated. As mentioned above, when the drawing air temperature is lowered to rapidly cool the extruded fiber, a larger amount of intermediate phase can be generated. The diameter of the extruded fiber is not particularly limited and may be the same as the fiber diameter of the fiber constituting the nonwoven fabric mentioned in the item [1]. When the diameter is small, the extruded fiber can be rapidly cooled and a larger amount of the intermediate phase can be generated.

In the case where the electret filter of the present invention is provided in the configuration shown in FIG. 1 and the supporting layer 120 is consisting of a nonwoven fabric, the preferable production method of the electret filter is one in which a nonwoven fabric for the dust collecting layer 110 and a nonwoven fabric for the supporting layer 120 are separately produced by the melt-blowing method, and these layers are integrated with each other. The order of production of the nonwoven fabrics is not particularly limited, and may be simultaneous. When the production of a nonwoven fabric for the dust collecting layer 110 and the production of a nonwoven fabric for the supporting layer 120 by are conducted simultaneously or continuously, a fiber constituting the nonwoven fabric for the dust collecting layer 110 and a fiber constituting the nonwoven fabric for the supporting layer 120 are effectively fusion bonded, thereby obtaining an integrated body excellent in shape retentivity.

The above-mentioned “electrostatic charging process” is a process in which a specific nonwoven fabric according to the present invention is charged by corona discharge. An apparatus and conditions for corona discharge are particularly limited. When a high voltage is applied onto a surface of the nonwoven fabric running on a grounded electrode from the above thereof using a needle electrode or wire electrode, corona discharge can be caused and the nonwoven fabric can be electrostatic charged. The degree of this electrostatic charge, i.e., of conversion into electret in other words, can be expressed by a surface electric charge density of the nonwoven fabric, as an index. The surface electric charge density of the nonwoven fabric after the electrostatic charging is not particularly limited. The surface electric charge density is preferably 2×10⁻¹⁰ coulomb/cm² or more, and particularly 5×10⁻¹⁰ coulomb/cm² or more. When the surface electric charge density is 2×10⁻¹⁰ coulomb/cm² or more, the electret filter is excellent in capability to separate and collect fine particles and the like in the air, being favorable.

In the case of manufacturing the electret filter in the configuration shown in FIG. 1, it is enough to integrate a nonwoven fabric for the dust collecting layer 110 with a nonwoven fabric for the supporting layer 120, and then conduct an electrostatic charging treatment for at least the surface of the nonwoven fabric for the dust collecting layer 110.

When a pleated electret filter is manufactured, a flat nonwoven fabric is preferably subject to pleat processing after the electrostatic charging process of the flat nonwoven fabric.

When the electret filter for a vehicular compartment interior is used, an air can be cleaned, thereby bringing the vehicular compartment interior into a comfortable atmosphere, and improving an occupant comfort.

### EXAMPLE

In the following, the present invention is described using Experimental Examples.

### [1] Experimental Examples 1 to 4

### Correlation Between MFR and Intermediate Phase-Transiting Heat Generation Amount of Polypropylene Resin

Test pieces for DSC measurement were prepared by adopting four kinds of isotactic propylene homopolymers having MFR's of 200 g per 10 minutes, 1,000 g per 10 minutes, 1,500 g per 10 minutes, and 1,800 g per 10 minutes, respectively. After that, 5 mg of the test piece was subjected to DSC measurement using a differential scanning calorimeter “DSC-60” manufactured by Shimadzu Corp. The temperature was elevated at a rate of 10° C. per minute from a heat starting temperature of 40° C. up to 200° C. Intermediate phase-transiting heat generation amounts in a temperature range from 80° C. to 120° C. were automatically calculated by a data analyzing device appended to the differential scanning calorimeter. The results are shown in Table 1.

TABLE 1

| | | MFR | Intermediate phase-transiting |
|---|---|---|---|
| | | (g/10 min.) | heat generation amount (J/g) |
| Experimental | 1 | 200 | 0 |
| Example | 2 | 1000 | 3.0 |
| | 3 | 1500 | 4.1 |
| | 4 | 1800 | 4.9 |

Apparent from the results in Table 1, Experimental Example 1 is an example wherein the polypropylene resin had an MFR of 200 g per 10 minutes, and an intermediate phase was not generated and a heat generation was not caused by transition of intermediate phase. On the other hand, Experimental Examples 2 to 4 are ones wherein MFR's were in the range from 1,000 to 1,800 g per 10 minutes, and intermediate phase-transiting heat generation amounts were 3.0 J/g or more. Particularly in Experimental Examples 3 and 4 where MFR's were 1,500 g per 10 minutes or more, heat generation amounts were 4.1 J/g or more, being higher. From these results, it is assumed that higher MFR of a polypropylene resin contained in a nonwoven fabric leads to a more increased heat generation amount, thereby enabling to sufficiently restrict deterioration of dust removing and dust collecting performances even when the nonwoven fabric is used at high temperatures over a long time.

### [2] Experimental Examples 5 to 8

### Correlation Between Cooling Rate of Fiber and Intermediate Phase-Transiting Heat Generation Amount

A resin having an MFR of 1,500 g per 10 minutes was used among the polypropylene resins in the above-mentioned item [1]. The resin was subjected to melting at a temperature of 230° C. and the molten resin was drawn out in the air so as to form a fiber shape having a diameter of 4 to 6 μm. After that, the extruded fiber was solidified in a water or hot water at temperatures of 0° C., 20° C., 40° C., or 60° C., separately. The thus obtained fibers were each processed to prepare a test piece and the intermediate phase-transiting heat generation amounts in a temperature range from 80° C. to 120° C. were measured in the same manner as that in the item [1]. The results are shown in Table 2.

TABLE 2

| | | Cooling | |
|---|---|---|---|
| | | temperature | Intermediate phase-transiting |
| | | (° C.) | heat generation amount (J/g) |
| Experimental | 5 | 0 | 8.3 |
| Example | 6 | 20 | 6.2 |
| | 7 | 40 | 5.7 |
| | 8 | 60 | 5.4 |

Apparent from the results in Table 2, Experimental Examples 5 and 6 are examples wherein temperatures of water were 20° C. or lower, and intermediate phase-transiting heat generation amounts were 6.2 J/g or more. Particularly in Experimental Example 5 where the water temperature was 0° C., the heat generation amount was 8.3 J/g, being higher. From these results, it is assumed that rapid cooling of a polypropylene resin contained in a nonwoven fabric leads to a more increased heat generation amount, thereby enabling to sufficiently restrict deterioration of dust removing and dust collecting performances even when the nonwoven fabric is used at high temperatures over a long time.

### [3] Experimental Examples 9 to 14

### Correlation Between Fiber Diameter and Intermediate Phase-Transiting Heat Generation Amount

A resin having an MFR of 1,500 g per 10 minutes was used among the polypropylene resins in the above-mentioned item [1]. The resin was subjected to melting at a temperature of 230° C. and the molten resin was drawn out in the air. After that, the extruded fiber was naturally cooled in the air to solidify. The thus obtained fibers having a diameter of 3 to 250 μm were each processed to prepare a test piece and the intermediate phase-transiting heat generation amounts in a temperature range from 80° C. to 120° C. were measured in the same manner as that in the item [1]. The results are shown in Table 3.

TABLE 3

| | | Fiber diameter | Intermediate phase-transiting |
|---|---|---|---|
| | | (μm) | heat generation amount (J/g) |
| Experimental | 9 | 3 | 6.2 |
| Example | 10 | 10 | 6.1 |
| | 11 | 20 | 6.0 |
| | 12 | 40 | 5.5 |
| | 13 | 100 | 5.2 |
| | 14 | 250 | 1.2 |

Apparent from the results in Table 3, Experimental Example 14 is an example wherein fiber diameter was 250 μm, and generation of the intermediate phase was little, and the intermediate phase-transiting heat generation amount was as low as 1.2 J/g. On the other hand, Experimental Examples 9 to 13 are ones wherein fiber diameters were in the range from 3 to 100 μm, and the intermediate phase-transiting heat generation amount was 5.2 J/g or more, thereby assuming that these examples enable to sufficiently restrict deterioration of dust removing and dust collecting performances even when the nonwoven fabric is used at high temperatures over a long time. In addition, while the considerable difference of heat generation amount was seen between the fiber diameters of 100 μm and 250 μm, differences were not so large over the fiber diameters of 3 to 100 μm, thereby assuming that extremely thin fibers are not necessarily required insofar as not particularly demanded.

### [4] Experimental Examples 15 to 17

### Correlation Between Intermediate Phase-Transiting Heat Generation Amount and Dust Collection Efficiency Deterioration Ratio

A resin having an MFR of 200 g per 10 minutes and a resin having an MFR of 1,500 g per 10 minutes were used among the polypropylene resins in the above-mentioned item [1]. The former resin was for Experimental Example 15 and the latter resin was for Experimental Examples 16 and 17. Each resin was subjected to melt-blowing using a melt-blow forming machine equipped with a cold air unit to prepare a nonwoven fabric for a dust collecting layer. Nonwoven fabrics for Experimental Examples 16 and 17 were different from each other in intermediate phase-transiting heat generation amount due to the different conditions for melt-blowing. The intermediate phase-transiting heat generation amount in a temperature range from 80° C. to 120° C. of the fiber constituting each nonwoven fabric was measured in the same manner as that in the item [1]. On the other hand, a polypropylene resin was subjected to melt-blowing using a melt-blow forming machine equipped with a cold air unit to prepare a nonwoven fabric for a supporting layer. The nonwoven fabric for the dust collecting layer and nonwoven fabric for the supporting layer were integrated at the same time of melt-blowing to form a nonwoven fabric laminate. The dust collecting layer side surface of the prepared nonwoven fabric laminate was subjected to electrostatic charging using a corona discharge device to produce an electret filter. The electrostatically charged electret filter was then cut to prepare a circular test piece having a diameter of 50 mm and a thickness of 2 mm. The test piece was subjected to measuring of dust collection efficiency for a fine particle having a diameter of 0.3 to 0.5 μm at a temperature of 25° C.±3° C. using an apparatus 1 shown in FIG. 5. Specifically, an air containing a fine particle having a diameter of 0.3 to 0.5 μm was flowed through a duct 11 from an upstream side U toward a downstream side L thereof at a wind velocity of 30 mm/sec, in a manner to measure the numbers of the fine particle at the upstream side U and downstream side L of an applicable test piece 2 interposed in the flow passage, by particle counter 12; and each dust collection efficiency was calculated from the following equation (1), based on the measured values at the upstream side U and downstream side L, respectively:

Dust collection efficiency (%)={(“number of particles at upstream side”−“number of particles at downstream side”)/(“number of particles at upstream side”)}×100 (1)

Subsequently, the electret filter was subjected to a heat treatment at a temperature of 80° C. for 50 hours, and a dust collection efficiency measurement was conducted at a temperature of 25° C.±3° C. in the same manner as the above to calculate a dust collection efficiency deterioration ratio by the following equation (2):

Dust collection efficiency deterioration ratio (%)=[(“dust collection efficiency before heat treatment”−“dust collection efficiency after heat treatment”)/(“dust collection efficiency before heat treatment”)]×100 (2)

TABLE 4

| | | Intermediate phase-transiting | |
|---|---|---|---|
| | | heat generation amount | Dust collection |
| | | of fiber constituting | efficiency |
| | | nonwoven fabric | deterioration |
| | | for dust collecting layer (J/g) | ratio (%) |
| Experimental | 15 | 0 | 40 |
| Example | 16 | 2.0 | 25 |
| | 17 | 4.0 | 15 |

Apparent from the results shown in Table 4, the dust collection efficiency was decreased down to as low as 40% due to the heat treatment, in case of the electret filter of Experimental Example 15 adopting the nonwoven fabric for which no heat generations were found by transition of intermediate phase. On the other hand, the dust collection efficiency deterioration ratios in Experimental Example 16 adopting the nonwoven fabric having the intermediate phase-transiting heat generation amount of 2.0 J/g, and in Experimental Example 17 adopting the nonwoven fabric having the intermediate phase-transiting heat generation amount of 4.0 J/g were 25% and 15%, respectively. It is understood therefrom that further increased intermediate phase-transiting heat generation amount leads to further decreased dust collection efficiency deterioration ratio to thereby keep excellent dust collection efficiency. Additionally, the fact that the dust collection efficiency deterioration ratio was as low as 15% such as in case of Experimental Example 17, corresponds to an extension of a lifetime of the electret filter up to five or more times longer.

### [5] Experimental Examples 18 to 21

### Effect of Additive

A resin having an MFR of 1,500 g per 10 minutes was used among the polypropylene resins in the above-mentioned item [1]. As the antioxidant pentaerythritol tetrakis[3-(3,5-di-tert-butyl-4-hydroxyphenyl)propionate] was used in an amount according to Table 5 to incorporate to the resin and prepare a polyolefin resin composition for forming a nonwoven fabric for dust collecting layer. The antioxidant was used for Experimental Examples 19 to 21 and not used in Experimental Example 18.

After that, the polyolefin resin composition and the polypropylene resin were used to produce a nonwoven fabric laminate having a dust collecting layer and supporting layer in the same manner as that in the item [4]. Subsequently, the dust collecting layer side surface of the nonwoven fabric laminate was subjected to electrostatic charging using a corona discharge device to produce an electret filter. Six sheets of test pieces were cut out from each of the electret filter to measure dust collection efficiency in the same manner as that in the item [4]. The average dust collection efficiency of six test pieces are shown in Table 5.

TABLE 5

| Experimental | Additive content | Dust collection |
|---|---|---|
| Example | (wt %) | efficiency (%) |
| 18 | 0 | 26 |
| 19 | 0.1 | 27 |
| 20 | 0.3 | 32 |
| 21 | 0.5 | 35 |

Apparent from the results in Table 5, the dust collection efficiency in Experimental Example 18 for the electret filter adopting the nonwoven fabric for dust collecting layer containing no additives is 26%. On the other hand, the dust collection efficiency in Experimental Example 19 for the electret filter adopting the nonwoven fabric for dust collecting layer containing 0.1% by weight of an antioxidant was 27%, being slightly improved. Further, the dust collection efficiencies in Experimental Examples 20 and 21 wherein the antioxidant was contained in amount of 0.3% by weight and 0.5% by weight were 32% and 35%, respectively, and it is seen that further increased amounts of the antioxidant resulted in the further improved efficiencies. These results indicate an improved effect of the dust collection efficiency by containing an antioxidant into a nonwoven fabric for dust collecting layer.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

What is claimed is:

1. An electret filter for vehicular compartment interior, comprising a nonwoven fabric which comprises a polyolefin resin having a melt flow rate of 1,000 to 3,000 g per 10 minutes, and a heat generation amount of 2.0 to 10.0 J/g in a temperature range from 80° C. to 120° C. when the temperature of said polyolefin resin is elevated at a rate of 10° C. per minute in a differential scanning calorimetric analysis.

2. The electret filter for vehicular compartment interior according to claim 1, wherein a diameter of a fiber in said nonwoven fabric is in the range from 0.3 to 150 μm.

3. A manufacturing method of an electret filter for vehicular compartment interior, comprising,
a process for producing by melt-blowing method, a nonwoven fabric which comprises a polyolefin resin having a melt flow rate of 1,000 to 3,000 g per 10 minutes, and a heat generation amount of 2.0 to 10.0 J/g in a temperature range from 80° C. to 120° C. when the temperature of said polyolefin resin is elevated at a rate of 10° C. per minute in a differential scanning calorimetric analysis, and
a process for electrostatic charging said nonwoven fabric by means of corona discharge.
